(19) United States
(12) Patent Application Publication
(10) Pub. No.: US 2025/0158024 A1
(43) Pub. Date: May 15, 2025

(54) POSITIVE ELECTRODE AND METHOD OF PRODUCING THE SAME, AND NON-AQUEOUS ELECTROLYTE SECONDARY BATTERY INCLUDING POSITIVE ELECTRODE AND METHOD OF PRODUCING THE SAME

(71) Applicant: Prime Planet Energy & Solutions, Inc., Tokyo (JP)

(72) Inventors: Keiichi TAKAHASHI, Nishinomiya-shi (JP); Takatoshi HIGUCHI, Kakogawa-shi (JP)

(21) Appl. No.: 18/896,898

(22) Filed: Sep. 26, 2024

(30) Foreign Application Priority Data
Nov. 10, 2023 (JP) 2023-192191

(51) Int. Cl. H01M 4/36; H01M 4/02; H01M 4/04; H01M 4/1391; H01M 4/525; H01M 4/58; H01M 4/62; H01M 10/058

(52) U.S. Cl. CPC H01M 4/364; H01M 4/0404; H01M 4/043; H01M 4/0471; H01M 4/1391; H01M 4/366; H01M 4/525; H01M 4/58; H01M 4/623; H01M 10/058; H01M 2004/021; H01M 2004/028

(57) ABSTRACT

A positive electrode has an active material layer. The active material layer includes an active material including at least a first active material, and a binding agent. The first active material is a first secondary particle consisting of first primary particles aggregated together and having a surface thereof covered with a boron compound. The first secondary particle is a lithium-(transition metal) composite oxide having a titanium compound at a grain boundary between the first primary particles and including Ni at 75 mol % or more relative to a total number of moles of metallic element except Li. The binding agent covers the first active material.

### CROSS REFERENCE TO RELATED APPLICATIONS

This nonprovisional application is based on Japanese Patent Application No. 2023-192191 filed on Nov. 10, 2023, with the Japan Patent Office, the entire contents of which are hereby incorporated by reference.

### BACKGROUND OF THE INVENTION

### Field of the Invention

The present invention relates to a positive electrode and a method of producing the same, and a non-aqueous electrolyte secondary battery including a positive electrode and a method of producing the same.

### Description of the Background Art

Japanese Patent Laying-Open No. 2007-273259 discloses heat treatment of a positive electrode plate at a temperature within a particular range for the purpose of enhancing storage properties and cycling performance of a non-aqueous electrolyte secondary battery (hereinafter also called “a secondary battery”), such as a lithium-ion battery, and also for the purpose of reducing expansion of a secondary battery.

### SUMMARY OF THE INVENTION

Recent secondary batteries for automotive applications have high capacity and high energy density. High-capacity secondary batteries tend to further expand along with repeated charge-discharge cycles, and restraining pressure to be applied for providing reaction force against the expansion needs to be increased. Hence, there is a demand for a method that allows for further reducing an increase of restraining pressure in a high-capacity secondary battery.

An object of the present disclosure is to provide a positive electrode that is capable of reducing an increase of reaction force during repeated charge-discharge cycles of a non-aqueous electrolyte secondary battery, and a method of producing the same, as well as a non-aqueous electrolyte secondary battery including a positive electrode and a method of producing the same.
[1]A positive electrode comprising:
an active material layer, wherein
the active material layer includes an active material including at least a first active material, and a binding agent,
the first active material is a first secondary particle consisting of first primary particles aggregated together and having a surface thereof covered with a boron compound,
the first secondary particle is a lithium-(transition metal) composite oxide having a titanium compound at a grain boundary between the first primary particles and including Ni at 75 mol % or more relative to a total number of moles of metallic element except Li, and
the binding agent covers the first active material.
[2] The positive electrode according to [1], wherein the binding agent covers 60% or more of a surface of the first active material.
[3] The positive electrode according to [1] or [2], wherein the boron compound includes Li.
[4] The positive electrode according to any one of [1] to [3], wherein a content of B in the first active material is from 0.5 to 3 mol % relative to the total number of moles of metallic element except Li.
[5] The positive electrode according to any one of [1] to [4], wherein the first secondary particle further forms a solid solution with Ti.
[6] The positive electrode according to any one of [1] to [5], wherein the first secondary particle includes Ti at 1 to 5 mol % relative to the total number of moles of metallic element except Li.
[7] The positive electrode according any one of [1] to [6], wherein
the binding agent is polyvinylidene difluoride, and
a content of the polyvinylidene difluoride in the active material layer is from 0.3 to 2 wt % relative to a weight of the active material layer.
[8] The positive electrode according to any one of [1] to [7], wherein the first secondary particle includes a lithium-(transition metal) composite oxide represented by the following formula (I):

Liₓ(Ni_{(1-y-z)}Co_{y}Me_{z})O₂ (I)
[where
1.0≤x≤1.2, 0.02≤y≤0.15, and 0.02≤z≤0.18 are satisfied, and
Me includes Ti and optionally includes one or more selected from the group consisting of Mn, Al, Mg, Mo, Nb, and Zr].
[9] The positive electrode according to any one of [1] to [8], wherein an amount of remaining alkali in the first active material is from 0.03 to 0.3 wt %.
[10] The positive electrode according to any one of [1] to [9], wherein
the active material further includes a second active material,
the first secondary particle consists of more than 100 first primary particles aggregated together,
the second active material is a single particle, or a second secondary particle consisting of up to 100 second primary particles aggregated together, and
an average particle size (D50) of the second active material is equal to or less than ⅓ of an average particle size (D50) of the first active material.
[11] The positive electrode according to [10], wherein the second active material includes a single-crystal particle.
[12] The positive electrode according to any one of [1] to [11], wherein an elastic modulus of the positive electrode is from 3 to 12 GPa.
[13]A non-aqueous electrolyte secondary battery comprising the positive electrode according to any one of [1] to [12].
[14]A method of producing a positive electrode having an active material layer, the method comprising:
forming a composite material layer by applying a composite material to a positive electrode current collector, drying, and compression; and
performing heat treatment of the composite material layer at a temperature within the range of a melting point of a binding agent to a pyrolytic temperature thereof, wherein
the composite material includes an active material including at least a first active material, and the binding agent,
the first active material is a first secondary particle consisting of first primary particles aggregated together and having a surface thereof covered with a boron compound, and
the first secondary particle is a lithium-(transition metal) composite oxide having a titanium compound at a grain boundary between the first primary particles and including Ni at 75 mol % or more relative to a total number of moles of metallic element except Li.
[15] The method of producing a positive electrode according to [14], wherein
a content of B in the first active material is from 0.5 to 3 mol %, and
the first secondary particle includes Ti at 1 to 5 mol % relative to the total number of moles of metallic element except Li.
[16] The method of producing a positive electrode according to [14] or [15], wherein
the binding agent is polyvinylidene difluoride, and
a content of the polyvinylidene difluoride in the active material layer is from 0.3 to 2 wt % relative to a weight of the active material layer.
[17]A method of producing a non-aqueous electrolyte secondary battery, the method comprising producing a positive electrode by the method of producing a positive electrode according to any one of [14] to [16].

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a descriptive view schematically illustrating a first active material included in an active material layer of a positive electrode according to an embodiment.

FIG. 2 is a flowchart illustrating a method of producing a positive electrode according to an embodiment.

### DESCRIPTION OF THE PREFERRED EMBODIMENTS

Herein, a numerical range such as “from x to y” includes the upper limit and the lower limit, unless otherwise specified. That is, “from x to y” means a numerical range of “not less than x and not more than y”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

### (Positive Electrode)

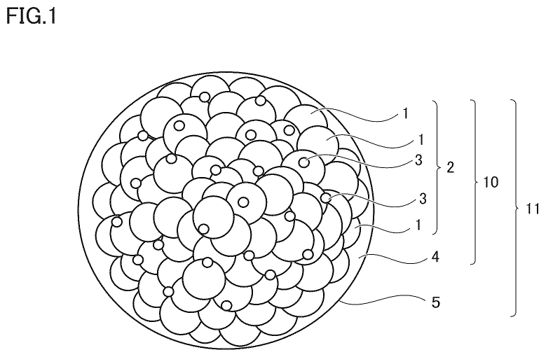

FIG. 1 is a descriptive view schematically illustrating a first active material included in an active material layer of a positive electrode according to an embodiment.

A positive electrode according to the present embodiment (hereinafter also called “the present positive electrode”) is used in, for example, a non-aqueous electrolyte secondary battery (hereinafter also called “a secondary battery”) such as a lithium-ion battery. The present positive electrode has an active material layer, and the active material layer includes an active material including at least a first active material 10, and a binding agent 5. First active material 10 is a first secondary particle 2 consisting of first primary particles 1 aggregated together and having a surface thereof covered with a boron compound (hereinafter also called “a B compound”) 4. First secondary particle 2 is a lithium-(transition metal) composite oxide having a titanium compound (hereinafter also called “a Ti compound”) 3 at a grain boundary between first primary particles 1 and including Ni at 75 mol % or more relative to a total number of moles of metallic element except Li. Binding agent 5 covers first active material 10. Hence, the active material layer includes a covered particle 11, which is first active material 10 that consists of first secondary particle 2 covered with B compound 4 on its surface, and that is further covered with binding agent 5 (FIG. 1).

The elastic modulus of the present positive electrode is preferably from 3 to 12 GPa, and may be from 5 to 10 GPa, or may be from 5 to 9 GPa, or may be from 6 to 8 GPa. When the elastic modulus falls within the above-mentioned range, the present positive electrode can have a proper degree of flexibility, and therefore an increase of reaction force during repeated charge-discharge cycles of the secondary battery tends to be reduced. The elastic modulus of the positive electrode can be adjusted to fit within the above-mentioned range by changing the type of the first active material included in the active material layer, the content of Ti compound 3 and B compound 4 in the first active material, and/or the like. The elastic modulus can be measured by a method described below in Examples, and it is calculated based on the change in the thickness of a stack of the positive electrodes when compression force is applied thereto in the stacking direction.

The present positive electrode may have the active material layer on a positive electrode current collector. The active material layer may be formed on only one side of the positive electrode current collector, or may be formed on both sides thereof. The positive electrode current collector is a metal foil that is made by using an aluminum material such as aluminum and aluminum alloy, for example, and the metal foil is not particularly limited as long as it is stable at the electric potential range of the present positive electrode. Preferably, the active material layer is formed on one side or both sides of the positive electrode current collector, except a portion to which a positive electrode lead is connected.

The active material includes at least first active material 10. First active material 10 is in particle form. First active material 10 is first secondary particle 2 consisting of first primary particles 1 aggregated together and having its surface covered with B compound 4. First secondary particle 2 preferably consists of more than 100 first primary particles 1 aggregated together, and the number of the first primary particles aggregated together may be 500 or more, or may be 1,000 or more, or may be 10,000 or more, and it is usually 5,000,000 or less.

First secondary particle 2 includes Ti compound 3 at the grain boundary between first primary particles 1. With Ti compound 3 present at the grain boundary between first primary particles 1, covered particle 11 that is covered well with binding agent 5 tends to be obtained. As a result, flexibility of the positive electrode can be enhanced, and, consequently, a positive electrode that is capable of reducing an increase of reaction force during repeated charge-discharge cycles of the secondary battery tends to be obtained.

Ti compound 3 included at the grain boundary between first primary particles 1 may be a compound that was formed of a non-Ti metallic element and Ti (which did not form a solid solution) and was precipitated during synthesis of first secondary particle 2 (described below). Ti compound 3 may be present on the surface of first primary particles 1, or may be present on the surface of first secondary particle 2. Preferably, Ti compound 3 present on the surface of first primary particles 1 is distributed not locally but all over the entire first secondary particle 2. In the case where Ti compound 3 is present on the surface of first secondary particle 2, it may be present in such a manner to cover the entire surface of first secondary particle 2, or it may be scattered throughout the surface of first secondary particle 2. When Ti compound 3 is in particle form, the particle size of the particle-form Ti compound 3 is preferably smaller than the particle size of first primary particles 1.

First secondary particle 2 includes Ti compound 3 at the grain boundary between first primary particles 1, and part of Ti may be present inside the first primary particles 1 or may form a solid solution. For example, Ti may form a solid solution with another metallic element such as a non-Ti transition metal element included in first primary particles 1.

Ti compound 3 is simply required to include Ti, and, for example, it may be a lithium-containing titanium compound represented by LiₚTi_{q}Oᵣ [where 1≤p≤4, 1≤q≤5, and 1≤r≤12]. The lithium-containing titanium compound may be produced by reaction of a titanium source used in the synthesis of first secondary particle 2, such as titanium oxide, with Li at the time of calcination performed during the synthesis of first secondary particle 2.

Preferably, first secondary particle 2 includes Ti at 1 to 5 mol % relative to the total number of moles of metallic element except Li. The content of Ti in first active material 10 relative to the total number of moles of metallic element except Li may be from 1 to 4 mol %, preferably is from 1 to 3 mol %, or may be from 1.5 to 3 mol %, or may be from 2 to 3 mol %. When the content of Ti in first secondary particle 2 falls within the above-mentioned range, covered particle 11 tends to be obtained, and, consequently, a positive electrode that is capable of reducing an increase of reaction force during repeated charge-discharge cycles of the secondary battery tends to be obtained.

Ti compound 3 present on the surface of first primary particles 1 or of first secondary particle 2, and Ti that forms a solid solution, can be checked with an SEM (a scanning transmission electron microscope), for example, and can be quantitatively assessed by ICP (high-frequency Inductively Coupled Plasma) emission spectrometry and/or XPS (X-ray photoelectron spectrometry). Ti that forms a solid solution with first primary particles 1 or with first secondary particle 2 can be quantitatively assessed by EDS (Energy Dispersive X-ray Spectrometry), for example. The presence of the Ti compound in the form of a lithium-containing titanium compound on the surface of first primary particles 1 or of first secondary particle 2 can be checked by Li mapping analysis with the use of an EPMA (an Electron Probe Micro Analyzer), EELS (Electron Energy Loss Spectroscopy), TOF-SIMS (Time-Of-Flight Secondary Ion Mass Spectrometry), XPS (X-ray Photoelectron Spectrometry), XRD (X-Ray Diffraction), and/or XAFS (X-ray Absorption Fine Structure). In the present specification, the Ti compound present at the grain boundary between first primary particles 1 and the Ti forming a solid solution were checked with an SEM and an EPMA, and the content of Ti was determined by ICP emission spectrometry, and the presence of the Ti compound in the form of a lithium-containing titanium compound was checked by analysis with an EPMA and by TOF-SIMS.

First secondary particle 2 is a lithium-(transition metal) composite oxide, and the content of Ni relative to the total number of moles of metallic element except Li (hereinafter also called “the Ni content”) is 75 mol % or more. The Ni content may be 78 mol % or more, or may be 80 mol % or more, or may be 82 mol % or more, or may be from 75 to 98 mol %, or may be from 80 to 95 mol %, or may be from 82 to 90 mol %. When the Ni content in first secondary particle 2 falls within the above-mentioned range, a secondary battery with high energy density can be obtained.

First secondary particle 2 includes Li, Ni, and Ti, and may also include other metallic elements. Examples of the metallic elements include one, two, or more metallic elements selected from the group consisting of Co, Mn, Al, Zr, Mg, Fe, Cu, Zn, Sn, Na, K, Ba, Sr, Ca, W, Mo, Nb, and Si.

Preferably, first secondary particle 2 includes a lithium-(transition metal) composite oxide represented by the following formula (I):

Liₓ(Ni_{(1-y-z)}Co_{y}Me_{z})O₂ (I)
[where
1.0≤x≤1.2, 0.02≤y≤0.15, and 0.02≤z≤0.18 are satisfied, and
Me includes Ti and optionally includes one or more selected from the group consisting of Mn, Al, Mg, Mo, Nb, and Zr].

In the formula (I), x may satisfy 1.01≤x≤1.09, or may satisfy 1.03≤x≤1.08, or may satisfy 1.05≤x≤1.07. In the formula (I), y may satisfy 0.03≤y≤0.12, or may satisfy 0.05≤y≤0.10, or may satisfy 0.06≤y≤0.09. In the formula (I), Me preferably includes Ti and also includes one or more selected from the group consisting of Mn and Al, and more preferably includes Ti and Mn. In the formula (I), z may satisfy 0.05≤z≤0.17, or may satisfy 0.1≤z≤0.16, or may satisfy 0.12≤z≤0.16.

First secondary particle 2 may be a lithium-(transition metal) composite oxide represented by the following formula (II), for example:

LiₐNi_{b}Co_{c}Mn_{d}TiₑO_{f} (II)
[where 0.8≤a≤1.2, b≥0.70, c≤0.10, 0.03≤d≤0.12, 0.01≤e≤0.05, 1≤f≤2, and b+c+d+e=1].

The composition of first secondary particle 2 can be determined by ICP (high-frequency Inductively Coupled Plasma) emission spectrometry.

For example, first secondary particle 2 can be synthesized by the procedure described below. Firstly, a Li source such as lithium hydroxide (LiOH) is added to a nickel compound containing at least Ni and calcined to obtain a lithium-nickel composite oxide. The nickel compound is a composite oxide or a composite hydroxide that contains Ni, Co, and Mn, for example. Then, a Ti source such as titanium dioxide (TiO₂) is added to the lithium-nickel composite oxide and calcined to obtain a lithium-(transition metal) composite oxide, and, thus, first secondary particle 2 is obtained. Along with the addition of the Ti source, a Li source such as lithium hydroxide may be added. The temperature for the calcination performed along with the addition of the Ti source is from 550 to 850° C., for example. For making a Ti compound present at the grain boundary between first primary particles 1 of first secondary particle 2, the amount of the Ti source to be added during the synthesis of first secondary particle 2 may be adjusted, for example.

First secondary particle 2 of first active material 10 is covered with B compound 4 on the surface thereof. With B compound 4 present on the surface of first secondary particle 2, covered particle 11 that is covered well with binding agent 5 tends to be obtained. As a result, flexibility of the positive electrode can be enhanced, and, consequently, a positive electrode that is capable of reducing an increase of reaction force during repeated charge-discharge cycles of the secondary battery tends to be obtained.

B compound 4 may preferably cover the entire surface of first secondary particle 2, or may be scattered throughout the surface of the first secondary particle. Preferably, B compound 4 present on the surface of first secondary particle 2 is distributed not locally but all over the entire first secondary particle 2. However, it is preferable that B compound 4 do not completely cover the entire surface of first secondary particle 2, and it is preferable that the surface of first secondary particle 2 have a region where B compound 4 is not adhered to. The proportion of coverage of the first secondary particle with B compound 4 is preferably 99% or less, and it may be 90% or less, or may be 70% or less, and it is usually 50% or more.

B compound 4 is simply required to include B, and, for example, it may include Li. The Li-containing B compound 4 may be produced by a reaction of a boron source used in the synthesis of first active material 10, such as boric acid, boron oxide, and lithium borate, with Li at the time of calcination performed during the synthesis of first active material 10.

The content of B (boron) in first active material 10 may be from 0.2 to 3 mol %, preferably from 0.5 to 3 mol %, or may be from 0.7 to 2.5 mol %, or may be from 0.8 to 2.3 mol %. When the content of B falls within the above-mentioned range, covered particle 11 that is covered well with binding agent 5 tends to be obtained. As a result, a positive electrode that is capable of reducing an increase of reaction force during repeated charge-discharge cycles of the secondary battery tends to be obtained.

The B compound in first active material 10 can be checked with an SEM (a scanning electron microscope), for example, and can be quantitatively assessed by ICP emission spectrometry, EPMA, XPS, and/or the like. The above-mentioned proportion of the area of the first secondary particle covered with B compound 4, relative to the total surface area, can be measured by EPMA or XPS. When EPMA is used, the ratio of the peak area attributed to B (boron) relative to the total peak area attributed to metallic element except Li may be calculated. When XPS is used, the molar fraction of B relative to the total number of moles of metallic element except Li may be calculated. Whether or not the B compound includes Li can be checked by Li mapping analysis by means of EELS and/or TOF-SIMS analysis. In the present specification, the B compound covering the first secondary particle was checked with an SEM, and the content of B was determined by ICP emission spectrometry, and inclusion of Li by the B compound was checked by TOF-SIMS.

First active material 10 can be synthesized by, for example, rinsing with water the first secondary particle 2 synthesized in the above-mentioned manner, adding a B source (a boron source) thereto, and calcination. Examples of the B source include boron compounds such as boric acid (H₃BO₃), boron oxide (B₂O₃), lithium borate (LiBO₂, Li₂B₄O₇), and the like. Along with the addition of the B source, a Li source such as lithium hydroxide may be added. The calcination temperature for the calcination performed along with the addition of the B source is from 200 to 500° C., for example.

The amount of remaining alkali in first active material 10 is preferably from 0.03 to 0.3 wt %, and may be from 0.05 to 0.25 wt %, or may be from 0.1 to 0.2 wt %. When the amount of remaining alkali in first active material 10 falls within the above-mentioned range, expansion and/or degradation of the secondary battery that can occur due to the gas produced by the remaining alkali can be reduced. The amount of remaining alkali in first active material 10 is determined by, as described below in Examples, measuring the pH of a suspension of first active material 10 in water.

The active material may include a second active material, in addition to first active material 10. The second active material is a single particle, or a second secondary particle consisting of up to 100 second primary particles aggregated together. When the second active material is a second secondary particle, the number of the second primary particles included in the second active material is preferably smaller than the number of first primary particles 1 included in first active material 10, and may be from 2 to 50, or may be from 2 to 30, or may be from 2 to 10, or may be from 2 to 5. The average particle size (D50) of the second active material is preferably equal to or less than ⅓, or may be equal to or less than ¼, or may be equal to or less than ⅕, of the average particle size (D50) of the first active material. The average particle size (D50) herein refers to the particle size in volume-based particle size distribution at which cumulative frequency of particle sizes accumulated from the small size side reaches 50%. The volume-based particle size distribution can be measured with a laser-diffraction particle size distribution analyzer.

As described below, the active material layer is formed by applying a composite material including an active material and a binding agent to a positive electrode current collector, drying, and compression. At the time of compression, the active material can become broken. It is also possible that the active material can become broken during charge-discharge cycles of the secondary battery. Breakage of the active material, when occurs, causes an increase of the specific surface area of the active material, making the reaction with electrolyte more likely to occur to produce gas, and/or making the expansion more likely to occur during charge and discharge of the secondary battery. The second active material tends not to break as compared to first active material 10, so when the active material layer includes the second active material, the above-mentioned gas production and/or expansion of the secondary battery can be reduced. From this viewpoint, each of the single particle and the second primary particle that constitute the second active material is preferably a single-crystal particle.

Preferably, the second active material is a lithium-(transition metal) composite oxide. The surface of the second active material may be or may not be covered with a B compound. Examples of the second secondary particle constituting the second active material include first secondary particle 2 mentioned in the description section for first active material 10. However, the second secondary particle may have or may not have a Ti compound at the grain boundary between the second primary particles. The lithium-(transition metal) composite oxide constituting the second active material may be the same as, or may be different from, the lithium-(transition metal) composite oxide constituting the first active material 10.

As long as the object of the present disclosure is not impaired, the active material may include another active material, in addition to first active material 10 and the second active material. This another active material may be a lithium-(transition metal) composite oxide in which the content of Ni does not fall within the corresponding range for first secondary particle 2, or a compound that is not a lithium-(transition metal) composite oxide. This another active material may be primary particles, or may be a secondary particle.

The active material layer includes binding agent 5. Binding agent 5 covers first active material 10. During repeated charge-discharge cycles of the secondary battery, due to the expansion and shrinkage of the active material, the active material can become broken and cracked. If the binding agent enters into the crack and becomes deposited there, the active material layer can become hard and the positive electrode can become less flexible, resulting in an increase of the elastic modulus of the positive electrode. A positive electrode with a high elastic modulus tends not to absorb the expansion and shrinkage of the active material and tends not to inhibit an increase of reaction force. On the other hand, first active material 10, which is covered with binding agent 5, tends not to cause an increase of the elastic modulus of the positive electrode. Especially because first active material 10 has Ti compound 3 at the grain boundary between first primary particles 1 and also the surface of first secondary particle 2 is covered with B compound 4, wettability between first active material 10 and binding agent 5 tends to be enhanced, and covered particle 11 that is covered well with binding agent 5 tends to be obtained. As a result, an increase of reaction force during repeated charge-discharge cycles of the secondary battery tends to be even further reduced.

Preferably, binding agent 5 covers 60% or more of the surface of first active material 10. The proportion of coverage of the surface of first active material 10 with binding agent 5 may be 70% or more, or may be 80% or more, or may be 85% or more, and, for example, it may be 98% or less, or may be 95% or less. When this proportion falls within the above-mentioned range, flexibility of the present positive electrode tends to be enhanced and an increase of reaction force during repeated charge-discharge cycles of the secondary battery tends to be reduced. The proportion of coverage of first active material 10 with binding agent 5 is calculated, as described below in Examples, by superimposing an image obtained by binarization processing of an SEM image of the active material layer on a mapping image of the binding agent corresponding to the SEM image and performing image analysis of the distribution of the binding agent.

Examples of binding agent 5 include fluororesins such as polyvinylidene difluoride (hereinafter also called “PVdF”) and polytetrafluoroethylene (PTFE); polyacrylonitrile (PAN); polyimide; acrylic resin; polyolefin; cellulose-based resins such as carboxymethylcellulose (CMC); and polyethylene oxide (POE). Preferably, binding agent 5 is PVdF.

When binding agent 5 is PVdF, the content of PVdF in the active material layer relative to the weight of the active material may be from 0.3 to 2 wt %, or may be from 0.5 to 1.8 wt %, or may be from 0.7 to 1.5 wt %. Even when the content of PVdF in the active material layer falls within the above-mentioned range, covered particle 11 that is covered well with PVdF can still be obtained, and, thereby an increase of reaction force during repeated charge-discharge cycles of the secondary battery can be efficiently reduced.

In addition to the active material and binding agent 5, the active material layer may also include a conductive material. Examples of the conductive material include a carbon material. The carbon material may be one or more selected from the group consisting of fibrous carbon, carbon black (such as acetylene black, Ketjenblack), coke, and activated carbon. Examples of the fibrous carbon include carbon nanotubes (CNTs). The CNTs may be single-walled carbon nanotubes (SWCNTs), or may be multi-walled carbon nanotubes such as double-walled carbon nanotubes (DWCNTs).

### (Method of Producing Positive Electrode)

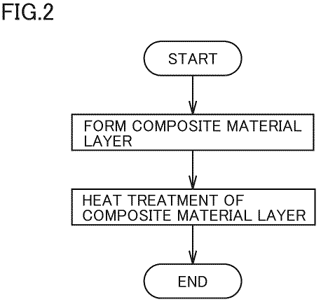

FIG. 2 is a flowchart illustrating a method of producing a positive electrode according to an embodiment. The method of producing a positive electrode according to the present embodiment is capable of producing a positive electrode for a secondary battery, and is also capable of producing the present positive electrode. The method of producing a positive electrode includes: forming a composite material layer by applying a composite material to a positive electrode current collector, drying, and compression; and performing heat treatment of the composite material layer at a temperature within the range of the melting point of a binding agent to the pyrolytic temperature thereof. The composite material includes an active material including at least a first active material, and a binding agent.

The first active material is a first secondary particle consisting of first primary particles aggregated together and having its surface covered with a B compound. The first secondary particle is a lithium-(transition metal) composite oxide having a Ti compound at the grain boundary between the first primary particles and including Ni at 75 mol % or more relative to the total number of moles of metallic element except Li. The binding agent covers the first active material.

The positive electrode current collector may be a metal foil that is described above. The first active material may be first active material 10 described above, and the first primary particles and the first secondary particle may be first primary particles 1 and first secondary particle 2 described above, respectively. The B compound and the Ti compound may be B compound 4 and Ti compound 3 described above, respectively. The content of Ni and the content of Ti in the first secondary particle, as well as the content of the B compound in the first active material may be set to fall within the above-mentioned range. The binding agent may be binding agent 5 described above, and preferably, it is PVdF. The content of PVdF in the active material layer may be set to fall within the above-mentioned range.

The composite material can be prepared by adding a solvent such as N-methyl-2-pyrrolidone (NMP) to an active-material-layer-forming material that contains the active material including the first active material, the binding agent, a conductive material if needed, and the like, and mixing and kneading.

In the step of forming a composite material layer, the composite material may be applied to only one side of the positive electrode current collector, or may be applied to both sides thereof. The composite material thus applied to the positive electrode current collector is dried and compressed, and thereby the composite material layer is obtained.

In the step of heat treatment, the composite material layer formed on the positive electrode current collector is subjected to heat treatment at a temperature within the range of the melting point of the binding agent to the pyrolytic temperature thereof. The temperature range for the heat treatment may be from the melting point to a temperature 100° C. higher than the melting point, or may be from a temperature 30° C. higher than the melting point to a temperature 60° C. higher than the melting point. The melting point and the pyrolytic temperature of the binding agent are regarded, respectively, as the melting point and the pyrolytic temperature of a binding agent that is included at a highest content (weight) among all the binding agents included in the composite material. When the heat treatment of the composite material layer is performed at a temperature within the above-mentioned range, the first active material can be covered well with the binding agent. Because the first active material has a B compound present on the surface of the first secondary particle which has a Ti compound at the grain boundary between the first primary particles, wettability between the binding agent and the first active material is enhanced. This makes it possible for the binding agent to cover the first active material well in the heat treatment step, and an increase of reaction force during repeated charge-discharge cycles of the secondary battery tends to be reduced. The melting point of the binding agent can be measured by differential scanning calorimetry (DSC), for example. The pyrolytic temperature of the binding agent can be measured with a thermogravimetry-differential thermal analysis apparatus (TG-DTA), for example.

### (Non-Aqueous Electrolyte Secondary Battery)

A non-aqueous electrolyte secondary battery according to the present embodiment (hereinafter also called “the present battery”) includes the present positive electrode, and usually includes an electrode assembly including the present positive electrode, as well as a non-aqueous electrolyte solution. The present battery may have a battery case for accommodating the electrode assembly and the non-aqueous electrolyte solution. The battery case can include an exterior package having an opening, and a sealing plate for sealing the opening. Each of the exterior package and the sealing plate is preferably made of metal, can be formed by using aluminum, aluminum alloy, iron, iron alloy, or the like, and, for example, can be formed by using an aluminum laminated film. Between the electrode assembly and the exterior package, a resin sheet may be provided as an electrode holder.

The electrode assembly may include the present positive electrode, a negative electrode, and a separator. In the electrode assembly, the active material layer of the present positive electrode faces a negative electrode active material layer of the negative electrode, with the separator interposed therebetween. The electrode assembly may be a stack-type one that is formed by stacking the present positive electrode, the negative electrode, and the separator, or may be a wound-type one that is formed by stacking the present positive electrode, the negative electrode, and the separator and winding the resulting stack.

The negative electrode usually has a negative electrode current collector and a negative electrode active material layer, and the negative electrode current collector is a metal foil that is made by using a copper material such as copper and copper alloy, for example. The negative electrode active material layer includes a negative electrode active material, and may further include a conductive material, a binder, and the like.

Examples of the negative electrode active material include carbon-based active material particles, metal-based active material particles, and the like. Examples of the carbon-based active material particles include particles of one or more types of carbon material selected from the group consisting of graphite such as natural graphite and artificial graphite, hard carbon, soft carbon, and amorphous-coated graphite. Examples of the metal-based active material particles include particles of a metallic element such as an elemental metal or a metal oxide including an element selected from the group consisting of silicon (Si), tin (Sn), antimony (Sb), bismuth (Bi), titanium (Ti), and germanium (Ge). Preferably, examples of the metal-based active material particles include particles of one or more types selected from the group consisting of Si, SiOx (x=0.5 to 1.5), a Si—C composite material (hereinafter also called “a SiC composite”), and Sn.

Examples of the conductive material include carbon materials such as fibrous carbon (CNTs (SWCNTs, DWCNTs)), carbon black (for example, acetylene black, Ketjenblack), coke, activated carbon, and the like. Examples of the binder include cellulose-based resins such as carboxymethylcellulose (CMC), methylcellulose (MC), and hydroxypropylcellulose; polyacrylic acid; SBR; and the like.

The separator has a base material, and may have a functional layer on at least one side of the base material. The base material can be a porous sheet such as a film and a nonwoven fabric made of a resin such as polyolefin such as polyethylene and/or polypropylene, polyester, cellulose, polyamide, and/or the like. The base material may have a monolayer structure or a multilayer structure. The functional layer may be either an adhesive layer or a heat-resistant layer, or both, for example. The adhesive layer can be formed with an adhesive agent, for example. The heat-resistant layer can include a filler and a binder, for example.

The non-aqueous electrolyte solution is preferably obtained by adding a supporting salt to a non-aqueous solvent such as an organic solvent. Examples of the supporting salt include LiPF₆, LiBF₄, LiClO₄, LiFSO₃, LiBOB (lithium bis(oxalato)borate), and the like. The non-aqueous electrolyte solution may include one, two, or more supporting salts, among these. Examples of the non-aqueous solvent include ethylene carbonate (EC), ethyl methyl carbonate (EMC), dimethyl carbonate (DMC), propylene carbonate (PC), butylene carbonate (BC), diethyl carbonate (DEC), and the like. The non-aqueous electrolyte solution can include one, two, or more non-aqueous solvents, among these. The non-aqueous electrolyte solution may further include an additive such as vinylene carbonate (VC), vinylethylene carbonate (VEC), and fluoroethylene carbonate.

### (Method of Producing Non-Aqueous Electrolyte Secondary Battery)

The method of producing the present battery includes a step to produce a positive electrode by the method of producing the present positive electrode. The method of producing the present battery may further include a step to obtain an electrode assembly by using the present positive electrode, a negative electrode, and a separator, and a step to place the electrode assembly and a non-aqueous electrolyte solution inside a battery case.

### EXAMPLES

In the following, the present disclosure will be described in further detail by way of Examples and Comparative Examples.

### Example 1

### (Synthesis of First Active Material)

Nickel-cobalt-manganese hydroxide, lithium hydroxide, and titanium dioxide were mixed together and calcined in an oxygen atmosphere at 770° C. for 10 hours, and thereby a lithium-(transition metal) composite oxide was obtained. The resulting lithium-(transition metal) composite oxide was pulverized and rinsed with water, and then mixed with boric acid and calcined at 300° C. for 1 hour, and thereby a first active material was obtained. The amount of titanium dioxide and boric acid was adjusted so that the amount of Ti and B to be included in the first active material became the amount specified in Table 1.

### (Production of Positive Electrode)

The resulting first active material, acetylene black, and polyvinylidene difluoride (PVdF; melting point, 175° C.; pyrolytic temperature, 420° C.) as a binding agent were mixed together in a solid matter weight ratio of 97.5:1.5:1.0, and mixed and kneaded with the addition of a proper amount of N-methyl-2-pyrrolidone (NMP) thereto, and thereby a composite material was obtained. The resulting composite material was applied to both sides of an aluminum foil serving as a positive electrode current collector and dried to form a coating film. The resulting coating film was rolled with a roller to form an active material layer, and the resultant was subjected to heat treatment at 230° C. for 3 minutes and then cut into the size of an electrode, and thereby a positive electrode having the active material layer formed on both sides of the positive electrode current collector was obtained. The melting point of the PVdF was measured by differential scanning calorimetry (DSC), and the pyrolytic temperature of the PVdF was measured with a thermogravimetry-differential thermal analysis apparatus (TG-DTA).

### (Production of Negative Electrode)

Natural graphite as a negative electrode active material, as well as sodium carboxymethylcellulose (CMC-Na) and styrene-butadiene rubber (SBR) as binders were mixed in water at a solid matter weight ratio of 100:1:1, and thereby a negative electrode composite material was obtained. The resulting negative electrode composite material was applied to both sides of a copper foil serving as a negative electrode current collector and dried to obtain a coating film. The resulting coating film was rolled with a roller to form a negative electrode active material layer, and the resultant was cut into the size of an electrode, and thereby a negative electrode having the negative electrode active material layer formed on both sides of the negative electrode current collector was obtained.

### (Production of Non-Aqueous Electrolyte Secondary Battery)

To a portion of the positive electrode current collector where the active material layer was not formed and the positive electrode current collector was exposed, an aluminum lead was welded as a positive electrode lead. To a portion of the negative electrode current collector where the negative electrode active material layer was not formed and the negative electrode current collector was exposed, a nickel lead was welded as a negative electrode lead. The positive electrode having the positive electrode lead and the negative electrode having the negative electrode lead were stacked on top of one another, with a separator made of polyolefin interposed therebetween, and the resultant was wound spirally and then shaped by pressing in the radial direction, and thereby a flat, wound-type electrode assembly was obtained. The resulting wound-type electrode assembly was placed inside an exterior package made of an aluminum-laminated sheet, and a non-aqueous electrolyte solution was injected thereinto, followed by sealing the opening of the exterior package, and thereby a secondary battery with a design capacity of 650 mAh was obtained.

The non-aqueous electrolyte solution included a mixed solvent, a supporting salt, and an additive, which are described below. As the mixed solvent, a mixture of ethylene carbonate (EC), ethyl methyl carbonate (EMC), and dimethyl carbonate (DMC) mixed in a volume ratio of EC:EMC:DMC=3:3:4 was used. Lithium hexafluorophosphate (LiPF₆) was used as the supporting salt, which was dissolved in the above-mentioned mixed solvent in a concentration of 1.0 mol/L. Vinylene carbonate (VC) was used as the additive, which was dissolved in the above-mentioned mixed solvent in a concentration of 2.0 weight %.

### Examples 2 to 5, Comparative Examples 1 to 4

A first active material and a positive electrode were obtained and a non-aqueous electrolyte secondary battery was produced by the procedure of Example 1 except that the amount of titanium dioxide and boric acid was adjusted so that the amount of Ti and B included in the first active material became the amount specified in Table 1 and Table 2.

### [Examination of First Active Material and Binding Agent]

### (Checking Ti)

The first active material was examined with a scanning transmission electron microscope (SEM; “JSM-7800F” manufactured by JEOL), and an EPMA (an electron probe micro analyzer) elemental mapping image corresponding to a 50000-time-magnification SEM image was acquired to check whether a Ti compound was present at the grain boundary between the first primary particles and whether Ti formed a solid solution with the first secondary particle. Results are given in Table 1 and Table 2. By EPMA and TOF-SIMS, it was identified that the Ti compound present at the grain boundary between the first primary particles was a lithium-containing titanium compound.

The first active material was examined with the above-mentioned SEM; an SEM image was acquired at a low acceleration of 1 kV and a magnification of 10000 times; from the presence of black region(s), it was presumed that B was present; and the state of coverage of the first secondary particle with a B compound was checked. Results are given in Table 1 and Table 2. The B compound covering the first secondary particle was checked by TOF-SIMS, and found to include Li.

As for the positive electrode obtained in Example 2 and Comparative Example 4, the first active material was examined with the above-mentioned SEM, and the state of coverage of the first active material with the binding agent (PVdF) was checked. The proportion of coverage of the first active material with fluorine elements was calculated as follows: a mapping image of fluorine (F) elements of the first active material covered with the binding agent was acquired; the resultant was superimposed on a binarized SEM image; and the fluorine distribution on the surface of the first active material was subjected to image analysis.

### [Composition of First Active Material]

The composition of the first active material was analyzed by ICP emission spectrometry, and the content of Ni, the content of B, and the content of Ti, relative to the total number of moles of metallic element except Li were measured. Results are given in Table 1 and Table 2. The first secondary particles in Examples 1 to 5 and Comparative Examples 1 to 4, respectively, were a lithium-(transition metal) composite oxide represented by the above-mentioned formula (I). The composition of the first secondary particle obtained in Examples 1 to 5 was Li_{1.04}Ni_{0.82}Co_{0.05}Mn_{0.13}Ti_{0.03}O₂.

### [Measurement of Amount of Remaining Alkali in First Active Material]

A certain amount of the first active material was dispersed in deionized water at 25° C., and thereby a dispersion was obtained. Hydrochloric acid was added dropwise to the resulting dispersion for neutralization titration, and from the titration curve thus obtained, the amount of alkali required for titration was calculated, which was regarded as the amount of remaining alkali. Results are given in Table 1 and Table 2.

### [Measurement of Elastic Modulus of Positive Electrode]

Eight pieces of positive electrode cut into a size of 30×40 mm were stacked, and the resulting stack was inserted into a laminated pouch, into which 1 g of electrolyte solution was injected, followed by vacuum-sealing the laminated pouch. The electrolyte solution was prepared by dissolving 1 mol/L LiPF₆ in a mixed solvent of EC:EMC:DMC=3:4:3 (volume ratio). With the use of autograph AGX-10kNV2D (manufactured by Shimadzu Corporation), compression force was applied in the stacking direction to the stack in the vacuum-sealed laminated pouch, and from the changes of thickness, the elastic modulus [GPa] was determined. More specifically, compression force was applied to the stack, with an increment of 0.5 kN per hour, and based on the strain change after a lapse of 4 h of compression force application (at the time when 2 kN of compression force was applied), the elastic modulus [GPa] was determined. Results are given in Table 1 and Table 2.

### [Measurement of Rate of Increase of Reaction Force of Secondary Battery]

The secondary battery was set on the jig of autograph AGX-10kNV2D (manufactured by Shimadzu Corporation), and while 1 MPa of restraining pressure was being applied thereto, charge and discharge were repeated at a value of current of ⅓ C rate to obtain an S—S curve (a stress-strain curve), and the load at this point was divided by the cross-sectional area of the secondary battery (cell) to calculate the stress value. The proportion of increment of the stress value at the time of charging after 200 cycles of charge and discharge relative to the stress value at the time of initial charging of the secondary battery was calculated, which was regarded as the rate [%] of increase of reaction force of the secondary battery. Results are given in Table 1 and Table 2.

TABLE 1

| | Example | | | | |
|---|---|---|---|---|---|
| | 1 | 2 | 3 | 4 | 5 |
| First active material | | | | | |
| Ti compound at grain | Yes | Yes | Yes | Yes | Yes |
| boundary between | | | | | |
| first primary particles | | | | | |
| Coverage of first | Yes | Yes | Yes | Yes | Yes |
| secondary particle | | | | | |
| with B compound | | | | | |
| Content of Ni [mol %] | ≥75 | ≥75 | ≥75 | ≥75 | ≥75 |
| Content of Ti [mol %] | 3 | 3 | 3 | 3 | 3 |
| Content of B [mol %] | 0.2 | 0.5 | 1 | 1.5 | 2 |
| Amount of remaining | 0.13 | 0.15 | 0.19 | 0.21 | 0.23 |
| alkali [wt %] | | | | | |
| Content of PVdF | 1.0 | 1.0 | 1.0 | 1.0 | 1.0 |
| in active material | | | | | |
| layer [wt %] | | | | | |
| Evaluation | | | | | |
| Elastic modulus | 6.8 | 6.8 | 6.3 | 7.5 | 9.5 |
| of positive | | | | | |
| electrode [GPa] | | | | | |
| Rate of increase | 20.9 | 12.9 | 11.7 | 11.5 | 11.3 |
| of reaction force of | | | | | |
| secondary battery [%] | | | | | |

TABLE 2

| | Comparative Example | | | |
|---|---|---|---|---|
| | 1 | 2 | 3 | 4 |
| First active material | | | | |
| Ti compound at grain boundary | No | No*¹ | Yes | No*² |
| between first primary particles | | | | |
| Coverage of first secondary | No | No | No | Yes |
| particle with B compound | | | | |
| Content of Ni [mol %] | ≥75 | ≥75 | ≥75 | ≥75 |
| Content of Ti [mol %] | 0 | 3 | 1 | 1 |
| Content of B [mol %] | 0 | 0 | 0 | 1 |
| Amount of remaining | 0.18 | 0.16 | 0.14 | 0.20 |
| alkali [wt %] | | | | |
| Content of PVdF in active | 1.0 | 1.0 | 1.0 | 1.0 |
| material laver [wt %] | | | | |
| Evaluation | | | | |
| Elastic modulus of positive | 10.6 | 8.7 | 10.4 | 9.2 |
| electrode [GPa] | | | | |
| Rate of increase of | 32.5 | 30.6 | 28.7 | 22.5 |
| reaction force of | | | | |
| secondary battery [%] | | | | |

*¹The first secondary particle and the Ti compound were mixed together.
*²Ti formed a solid solution with the first primary particles.

### Example 6

A positive electrode was obtained by the procedure of Example 2 except that the proportion of polyvinylidene difluoride to the first active material was changed to 100:1.5 (solid matter weight ratio). The state of coverage of the first active material with PVdF was checked by the above-mentioned method, and it was found that PVdF covered 89% of the first active material.

### Comparative Example 5

A positive electrode was obtained by the procedure of Comparative Example 4 except that the proportion of polyvinylidene difluoride to the first active material was changed to 100:1.5 (solid matter weight ratio). The state of coverage of the first active material with PVdF was checked by the above-mentioned method, and it was found that PVdF covered 51% of the first active material.

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A positive electrode comprising:
an active material layer, wherein
the active material layer includes an active material including at least a first active material, and a binding agent,
the first active material is a first secondary particle consisting of first primary particles aggregated together and having a surface thereof covered with a boron compound,
the first secondary particle is a lithium-(transition metal) composite oxide having a titanium compound at a grain boundary between the first primary particles and including Ni at 75 mol % or more relative to a total number of moles of metallic element except Li, and
the binding agent covers the first active material.

2. The positive electrode according to claim 1, wherein the binding agent covers 60% or more of a surface of the first active material.

3. The positive electrode according to claim 1, wherein the boron compound includes Li.

4. The positive electrode according to claim 1, wherein a content of B in the first active material is from 0.5 to 3 mol % relative to the total number of moles of metallic element except Li.

5. The positive electrode according to claim 1, wherein the first secondary particle further forms a solid solution with Ti.

6. The positive electrode according to claim 1, wherein the first secondary particle includes Ti at 1 to 5 mol % relative to the total number of moles of metallic element except Li.

7. The positive electrode according to claim 1, wherein
the binding agent is polyvinylidene difluoride, and
a content of the polyvinylidene difluoride in the active material layer is from 0.3 to 2 wt % relative to a weight of the active material layer.

8. The positive electrode according to claim 1, wherein the first secondary particle includes a lithium-(transition metal) composite oxide represented by the following formula (I):
Liₓ(Ni_{(1-y-z)}Co_{y}Me_{z})O₂ (I)
[where
1.0≤x≤1.2, 0.02≤y≤0.15, and 0.02≤z≤0.18 are satisfied, and
Me includes Ti and optionally includes one or more selected from the group consisting of Mn, Al, Mg, Mo, Nb, and Zr].

9. The positive electrode according to claim 1, wherein an amount of remaining alkali in the first active material is from 0.03 to 0.3 wt %.

10. The positive electrode according to claim 1, wherein
the active material further includes a second active material,
the first secondary particle consists of more than 100 first primary particles aggregated together,
the second active material is a single particle, or a second secondary particle consisting of up to 100 second primary particles aggregated together, and
an average particle size (D50) of the second active material is equal to or less than ⅓ of an average particle size (D50) of the first active material.

11. The positive electrode according to claim 10, wherein the second active material includes a single-crystal particle.

12. The positive electrode according to claim 1, wherein an elastic modulus of the positive electrode is from 3 to 12 GPa.

13. A non-aqueous electrolyte secondary battery comprising the positive electrode according to claim 1.

14. A method of producing a positive electrode having an active material layer, the method comprising:
forming a composite material layer by applying a composite material to a positive electrode current collector, drying, and compression; and
performing heat treatment of the composite material layer at a temperature within the range of a melting point of a binding agent to a pyrolytic temperature thereof, wherein
the composite material includes an active material including at least a first active material, and the binding agent,
the first active material is a first secondary particle consisting of first primary particles aggregated together and having a surface thereof covered with a boron compound, and
the first secondary particle is a lithium-(transition metal) composite oxide having a titanium compound at a grain boundary between the first primary particles and including Ni at 75 mol % or more relative to a total number of moles of metallic element except Li.

15. The method of producing a positive electrode according to claim 14, wherein
a content of B in the first active material is from 0.5 to 3 mol %, and
the first secondary particle includes Ti at 1 to 5 mol % relative to the total number of moles of metallic element except Li.

16. The method of producing a positive electrode according to claim 14, wherein
the binding agent is polyvinylidene difluoride, and
a content of the polyvinylidene difluoride in the active material layer is from 0.3 to 2 wt % relative to a weight of the active material layer.

17. A method of producing a non-aqueous electrolyte secondary battery, the method comprising producing a positive electrode by the method of producing a positive electrode according to claim 14.
